(19) United States
(12) Patent Application Publication
(10) Pub. No.: US 2005/0232087 A1
(43) Pub. Date: Oct. 20, 2005

(54) Magnetic head device and magneto-optical disc apparatus

(75) Inventors: Yutaka Murakami, Osaka (JP); Hironori Tomita, Ikoma-shi (JP)

Correspondence Address: AKIN GUMP STRAUSS HAUER & FELD L.L.P., ONE COMMERCE SQUARE, 2005 MARKET STREET, SUITE 2200, PHILADELPHIA, PA, 19103, US

(73) Assignee: Matsushita Electric Industrial Co., Ltd.

(21) Appl. No.: 11/025,346

(22) Filed: Dec. 29, 2004

(30) Foreign Application Priority Data
Mar. 30, 2004 (JP) 2004-098923

(51) Int. Cl. G11B 11/00

(52) U.S. Cl. 369/13.01

(57) ABSTRACT

A magnetic head device includes a head main body for applying a magnetic field to an information recording medium; a connecting member including a main part and an elastic part connected to the main part, the elastic part supporting the head main body such that the head main body is swingable; a first position restriction member provided at the head main body for restricting a position of the head main body by contacting the elastic part; and a second position restriction member for restricting a position of the head main body by restricting a position of the first position restriction member which in contact with the elastic part.

### BACKGROUND OF THE INVENTION

The present invention relates to a magnetic head device for applying a magnetic field to an information recording medium, and a magneto-optical disc apparatus including the same.

Magneto-optical discs represented by mini discs (hereinafter, referred to as “MDs”) are known as one type of information recording mediums. A magneto-optical disc includes a plurality of layers having a magneto-optical recording layer. The magneto-optical disc is accommodated in a cartridge. The cartridge has an opening for exposing both of two surfaces of a part of the magneto-optical disc and a shutter movable so as to open or close the opening.

A magneto-optical disc apparatus records information on a magneto-optical disc mounted thereon and/or reproduces information recorded on a magneto-optical disc mounted thereon. The magneto-optical disc apparatus includes a disc rotation driving mechanism for rotating a magneto-optical disc, an optical head device provided on the side of one surface of the magneto-optical disc for irradiating a magneto-optical recording layer of the magneto-optical disc with a converged optical beam, and a magnetic head device provided on the side of the other surface of the magneto-optical disc for applying a magnetic field to the magneto-optical recording layer of the magneto-optical disc. The magnetic head device is located so as to face the optical head device with the mounted magneto-optical disc interposed therebetween.

When the magneto-optical disc is mounted on the magneto-optical disc apparatus, the shutter of the cartridge moves to open the opening of the cartridge, and thus both of the two surfaces of a part of the magneto-optical disc is exposed through the opening. When the magneto-optical disc apparatus is driven, the disc rotation driving mechanism rotates the magneto-optical disc. One exposed surface of the magneto-optical disc is irradiated with an optical beam, which is obtained by converging light by an optical system of the optical head device. At this point, a magnetic field is applied to the other exposed surface of the magneto-optical disc by the magnetic head device. The direction of the magnetic field applied by the magnetic head device is modulated in accordance with the information to be recorded. When a part of the magneto-optical recording layer of the magneto-optical disc, which is irradiated with the light beam, is heated to the Curie temperature or a higher temperature by the irradiation with the optical beam, the heated part of the magneto-optical recording layer loses a coercive force thereof and is magnetized in a direction in accordance with the direction of the magnetic field applied by the magnetic head device. Since the magneto-optical disc is being rotated by the disc rotation driving mechanism, the heated part of the magneto-optical recording layer moves relative to the optical beam and goes into the state where the part is not irradiated with the optical beam anymore. When this occurs, the temperature of that part of the magneto-optical recording layer becomes lower than the Curie temperature, and thus the direction of magnetization is fixed.

Binary information can be recorded on the magneto-optical disc by fixing the direction of magnetization of a predetermined part of the magneto-optical recording layer in accordance with the information to be recorded in this manner. For reproducing information recorded on the magneto-optical disc, the magneto-optical disc is irradiated with an optical beam having such an intensity that does not influence the direction of magnetization of the magneto-optical recording layer of the magneto-optical disc, and light reflected by the magneto-optical disc is detected. The polarization direction of the light reflected by the magneto-optical disc varies in accordance with the direction of magnetization of the magneto-optical recording layer. Therefore, binary information recorded on the magneto-optical disc can be reproduced by detecting the polarization direction of the light reflected by the magneto-optical disc.

While the magneto-optical disc is rotating, the surface of the magneto-optical disc may sometimes vibrate. In order to compensate for this, the magnetic head device of the magneto-optical disc apparatus includes a supporting member swingable in the direction in which the surface of the magneto-optical disc may vibrate, and a head main body for applying a magnetic field to the magneto-optical disc is attached to a tip of the supporting member. The head main body includes a slidable body which is slidable in contact with, or floatable at a very fine distance from, the magneto-optical disc. The head main body also includes a magnetic head element. In the following explanation, the slidable body is slidable in contact with the magneto-optical disc.

The position of the magnetic head device for recording information on the magneto-optical disc is different from the position of the magnetic head device for reproducing information recorded on the magneto-optical disc. For recording information on the magneto-optical disc, the magnetic head device is close to the magneto-optical disc in order to apply a magnetic field to the magneto-optical disc. By contrast, for reproducing information recorded on the magneto-optical disc, the magnetic head device is not close to the magneto-optical disc. The magnetic head device is not close to the magneto-optical disc except for when recording information on the magneto-optical disc. For example, after the magneto-optical disc is dismounted from the magneto-optical disc apparatus, the magnetic head device is not close to the magneto-optical disc. For recording information on the magneto-optical disc, the magnetic head device moves so as to close to the magneto-optical disc apparatus. In this specification, the position of a magnetic head device for recording information on a magneto-optical disc is referred to as a “first position”, and the position of the magnetic head device except for when recording information on a magneto-optical disc is referred to as a “second position”. When the magnetic head device is at the first position, the slidable body of the magnetic head device is close to the magneto-optical disc, and is slidable in contact with the magneto-optical disc. When the magnetic head device is at the second position, the supporting member and the head main body are lifted by a lifting mechanism and are separated from the magneto-optical disc.

Japanese Laid-Open Patent Publication No. 9-161427 discloses a conventional magnetic head device. With reference to FIGS. 24A through 27, a conventional magnetic head device 110 disclosed in Japanese Laid-Open Patent Publication No. 9-161427 will be described.

As shown in FIG. 24A, a fixing plate 140 fixes a magnetic head 118. The magnetic head 118 includes a head main body 120 and a supporting member 137 for supporting the head main body 120 and pressing the head main body 120 to a magneto-optical disc. The supporting member 137 is formed of a thin spring plate formed of, for example, stainless steel or phosphorus bronze. One end of the supporting member 137 is fixed to the fixing plate 140 by means of, for example, spot welding or bonding.

The supporting member 137 includes a first elastic part 138 provided in the vicinity of the fixing plate 140, a rigid part 136 connected to the first elastic part 138, and a second elastic part 132 connected to the rigid part 136. The rigid part 136 has recessed portions and projecting portions formed by drawing. The rigid part 136 acts as a rigid body for the first elastic part 138 and the second elastic part 132. The second elastic part 132 is branched into two portions, and the two branched portions are connected to each other at tips thereof. A gimbal 132a is provided at the connected tip of the second elastic part 132. The head main body 120 is attached to the gimbal 132a. The second elastic part 132 has an opening. The head main body 120 is located in the opening of the second elastic part 132, and is supported by the second elastic part 132 by means of, for example, bonding or fusion so as to be swingable.

The head main body 120 includes a magnetic core 126. The magnetic core 126 is attached to a coil 127 of a conductive line (not shown in FIGS. 24A and 24B; see FIGS. 25B and 25C). Ends of the conductive line are fixed to a flexible printed board (hereinafter, referred to as an “FPC”) 180 by soldering, and the coil 127 is electrically connected to the FPC 180 via the solder. When an electric current corresponding to a signal to be recorded flows from the FPC 180, a magnetic field in correspondence with the electric current is applied to the magneto-optical disc 112 from the central magnetic pole of the magnetic core 126. An upper position restriction member 122 is provided at the head main body 120.

The fixing plate 140 is connected to an arm member 142 extending toward the head main body 120 (i.e., in the −Y direction). A tip of the arm member 142 is connected to a position restriction member 144 extending in the +X direction.

As shown in FIG. 24B, the first elastic part 138 acts to allow the head main body 120 to follow the vibration of the surface of the magneto-optical disc, and the second elastic part 132 acts to allow the head main body 120 to follow the tilt of the magneto-optical disc. The head main body 120 includes a slidable body 123, which has a slidable portion 123a which is slidable in contact with the magneto-optical disc. The upper position restriction member 122 restricts the position of the head main body 120 in the −Z direction.

Hereinafter, the head main body 120 will be described in detail.

As shown in FIGS. 25A, 25B and 25C, the head main body 120 includes a mounting member 121, the slidable body 123 attached to the mounting member 121, and a magnetic head element 124 accommodated in the mounting member 121. The magnetic head element 124 applies a magnetic field. The upper position restriction member 122 includes two upper position restriction portions (i.e., upper position restriction portions 122a and 122b). The upper position restriction portion 122a extends from the mounting member 121 in +X direction, and the upper position restriction portion 122b extends from the mounting member 121 in the −X direction. The upper position restriction member 122 is integrally molded with the mounting member 121 of a resin material. The slidable body 123 is integrally fixed to the mounting member 121 by, for example, an adhesive, or is integrally molded with the mounting member 121 of a resin material. The slidable body 123 is formed of a resin material having a high slidability, for example, polyphenylene sulfide or a liquid crystal polymer. The slidable body 123 has the slidable portion 123a which is slidable in contact with the magneto-optical disc. The slidable portion 123a is provided such that the slidable body 123 can stably contact the magneto-optical disc.

The magnetic head element 124 includes a bobbin 125, the magnetic core 126, and the coil 127. As shown in FIG. 25B, the magnetic core 126 has generally E-shaped, and is formed of a soft magnetic material such as, for example, sintered ferrite. The coil 127 is formed by winding a conductive line around the bobbin 125. The magnetic core 126 is attached to the coil 127 such that the coil 127 surrounds the central magnetic pole of the magnetic core 126 having the generally E shape. Both of two ends of the conductive line wound around the bobbin 125 are fixed to the FPC 180 (see FIGS. 24A and 24B) by soldering. The coil 127 is electrically connected to the FPC 180 by the solder, and the electric current from the FPC 180 flows through the coil 127.

With reference to FIGS. 26 and 27, operations of the magnetic head device for recording information on a magneto-optical disc and for reproducing information recorded on a magneto-optical disc will be described.

As shown in FIG. 26, the fixing plate 140 is fixed to a magnetic head device attachment member 171, which has a mechanism for allowing the fixing plate 140 to rotate within the Y-Z plane. For recording information on a magneto-optical disc 112, the magnetic head device 110 moves from the second position to the first position. At this point, a lifting mechanism 175 pivots in a direction of separating from the supporting member 137 and approaching a magneto-optical disc 112, and the magnetic head device attachment member 171 is tilted downward (in the −Z direction). Therefore, the head main body 120 moves to a position close to the magneto-optical disc 112. The supporting member 137 supplies the head main body 120 with a force in a direction of pressing the head main body 120 to the magneto-optical disc 112. Thus, the head main body 120 can be slide in contact with the rotating magneto-optical disc 112.

As shown in FIG. 27, for reproducing information recorded on the magneto-optical disc 112, the magnetic head device 110 moves from the first position to the second position. At this point, the lifting mechanism 175 pivots in a direction of separating from the magneto-optical disc 112, and contacts the supporting member 137 and the arm member 142 to lift the supporting member 137 and the arm member 142, and the magnetic head device attachment member 171 is tilted upward (in the +Z direction). Therefore, the head main body 120 is separated from the magneto-optical disc 112. At this point, the position restriction member 144 is in contact with the rigid part 136. In FIGS. 26 and 27, the cartridge is omitted.

The magneto-optical disc apparatus is often carried around and thus sometimes receives a strong impact by falling or transportation. In such a case, the magnetic head device 110 of the magneto-optical disc apparatus receives an impact as strong as about 1000 m/s² to 5000 m/s². Although the magnetic head device 110 has two elastic parts (the first elastic part 138 and the second elastic part 132) as described above, these elastic parts do not act as elastic parts once they are plastically deformed by the impact.

When the magnetic head device 110 receives an impact in the −Z direction, the rigid part 136 approaches and contacts the position restriction member 144, and thus the position restriction member 144 restricts the position of the rigid part 136 in the −Z direction. In this manner, the position restriction member 144 prevents the first elastic part 138 from being plastically deformed.

When the magnetic head device 110 receives an impact in the −Z direction, the head main body 120 moves in the −Z direction, and the upper position restriction member 122 provided at the head main body 120 contacts the second elastic part 132. The upper position restriction member 122, which restricts the position of the head main body 120 in the −Z direction, prevents the second elastic part 132 from being plastically deformed.

The head main body 120 provided at the tip of the magnetic head device 110 is relatively heavy, and the second elastic part 132 for supporting the head main body 120 is most liable to be plastically deformed. In the magnetic head device 110 disclosed in Japanese Laid-Open Patent Publication No. 9-161427, the upper position restriction member 122 restricts the position of the head main body 120 and prevents the second elastic part 132 from being plastically deformed. However, when the magnetic head device 110 receives a very strong impact, the head main body 120 providing with the upper position restriction member 122 may undesirably move in the −Z direction while the upper position restriction member 122 is in contact with the second elastic part 132, resulting in deformation of the second elastic part 132.

The present invention has an object of providing a magnetic head device and a magneto-optical head apparatus having high reliability against an impact caused by falling, transportation or the like.

### SUMMARY OF THE INVENTION

According to one aspect of the present invention, a magnetic head device includes a head main body for applying a magnetic field to an information recording medium; a connecting member including a main part and an elastic part connected to the main part, the elastic part supporting the head main body such that the head main body is swingable; a first position restriction member provided at the head main body for restricting a position of the head main body by contacting the elastic part; and a second position restriction member for restricting a position of the head main body by restricting a position of the first position restriction member which in contact with the elastic part.

In one embodiment of the invention, the second position restriction member is located so as to face the first position restriction member with the elastic part interposed therebetween.

In one embodiment of the invention, the second position restriction member restricts the position of the first position restriction member by contacting at least one of the elastic part and the first position restriction member.

In one embodiment of the invention, the second position restriction member is provided at the main part.

In one embodiment of the invention, the main part includes a rigid part connected to the elastic part and another elastic part connected to the rigid part.

In one embodiment of the invention, the elastic part, the rigid part and the another elastic part are formed of a supporting member.

In one embodiment of the invention, the main part further includes a fixing part for fixing the supporting member.

In one embodiment of the invention, the main part further includes an arm member, and the second position restriction member is attached to the arm member.

In one embodiment of the invention, the arm member is connected to the fixing part.

In one embodiment of the invention, the arm member is provided so as to be pivotable with respect to the fixing part.

In one embodiment of the invention, the second position restriction member has a slidable projection at an end thereof.

In one embodiment of the invention, the slidable projection has a curved surface.

In one embodiment of the invention, the second position restriction member is provided at the rigid part.

In one embodiment of the invention, the first position restriction member is located in the vicinity of the center of gravity of the head main body.

In one embodiment of the invention, the connecting member has a free end and a fixed end, the elastic part of the connecting member is located on the side of the free end, and the main part is located on the side of the fixed end. The first position restriction member is located at an area of the head main body which is other than an area of the head main body closest to the fixed end of the connecting member.

In one embodiment of the invention, the first position restriction member is provided at the head main body, such that a force in a direction opposite to a direction in which the center of gravity of the head main body moves is given to the center of gravity of the head main body by the first position restriction member contacting the elastic part.

In one embodiment of the invention, the connecting member extends in a first direction, and the first position restriction member is provided so as to be perpendicular to the first direction.

In one embodiment of the invention, the magnetic head device further includes a third position restriction member for restricting a position of the main part.

In one embodiment of the invention, the second position restriction member is attached to the third position restriction member.

In one embodiment of the invention, the magnetic head device further includes a fourth position restriction member provided at the head main body for restricting a position of the head main body by contacting the main part.

In one embodiment of the invention, the magnetic head device is movable between a first position, at which the head main body is slidable in contact with the information recording medium or floatable at a fine distance from the information recording medium, and a second position, at which the head main body is separated from the information recording medium.

According to another aspect of the invention, a magnetic head device includes a head main body for applying a magnetic field to an information recording medium; a connecting member including a main part and an elastic part connected to the main part, the elastic part supporting the head main body such that the head main body is swingable; a first position restriction member provided at the head main body; and a second position restriction member for restricting a position of the head main body by restricting a position of the first position restriction member. The main part includes a high rigidity part having a higher rigidity than the rigidity of the elastic part. The second position restriction member is connected to the high rigidity part.

In one embodiment of the invention, the second position restriction member restricts a position of the first position restriction member by contacting the first position restriction member.

In one embodiment of the invention, the elastic part has an opening. The first position restriction member moves in the opening of the elastic part to contact the second position restriction member.

In one embodiment of the invention, the elastic part has an opening. The head main body is located in the opening of the elastic part. The first position restriction member is provided at the head main body so as to bridge over the elastic part. A part of the first position restriction member moves outside the elastic part to contact the second position restriction member.

In one embodiment of the invention, the main part includes a rigid part connected to the elastic part, another elastic part connected to the rigid part, and a fixing part connected to the another elastic part. The high rigidity part is the fixing part. The second position restriction member is connected to the fixing part.

In one embodiment of the invention, the main part includes a rigid part connected to the elastic part, and another elastic part connected to the rigid part. The high rigidity part is the rigid part. The second position restriction member is connected to the rigid part.

According to another aspect of the invention, a magneto-optical disc apparatus includes any of the above-described magnetic head device; and an optical head device.

According to the present invention, the reliability of the magnetic head device and the magneto-optical disc apparatus against the impact can be improved.

### BRIEF DESCRIPTION OF THE DRAWINGS

FIG. 1A is an exploded perspective view of a magneto-optical disc apparatus according to a first embodiment of the present invention.

FIG. 1B is a perspective view of a magnetic head device used in the magneto-optical disc apparatus according to the first embodiment.

FIG. 2 is a partial perspective view of the magnetic head device according to the first embodiment.

FIG. 3 is a plan view of a fixing plate, an arm member, a fourth position restriction member and a second position restriction member of the magnetic head device according to the first embodiment.

FIG. 4 is an exploded perspective view of a head main body and a first position restriction member of the magnetic head device according to the first embodiment.

FIG. 5 is a front view of the magnetic head device according to the first embodiment at a first position.

FIG. 6 is a front view of the magnetic head device according to the first embodiment at a second position.

FIG. 7 is a plan view of the magnetic head device according to the first embodiment.

FIG. 8 is a cross-sectional view of FIG. 7 taken along line A-A′ in FIG. 7.

FIG. 9 is a plan view of the magnetic head device according to the first embodiment.

FIG. 10 is a front view of the magnetic head device according to the first embodiment.

FIG. 11 is a cross-sectional view of FIG. 9 taken along line A-A′ in FIG. 9.

FIG. 12 is a partial perspective view of a magnetic head device according to a second embodiment of the present invention.

FIG. 13 is a front view of the magnetic head device according to the second embodiment at the second position.

FIG. 14 is a perspective view of a magnetic head device according to a third embodiment of the present invention.

FIG. 15 is a front view of the magnetic head device according to the third embodiment at the first position.

FIG. 16 is a rear view of a fixing plate, a pivotable arm member, a fourth position restriction member and the second position restriction member of the magnetic head device according to the third embodiment.

FIG. 17 is a partial perspective view of a magnetic head device according to a fourth embodiment of the present invention.

FIG. 18 is a partial rear view of the magnetic head device according to the fourth embodiment.

FIG. 19 is a front view of the magnetic head device according to the fourth embodiment at the first position.

FIG. 20 is a perspective view of a magnetic head device according to a fifth embodiment of the present invention.

FIG. 21 is a partial plan view of the magnetic head device according to the fifth embodiment.

FIG. 22 is a perspective view of a magnetic head device according to a modification of the fifth embodiment of the present invention.

FIG. 23 is a partial rear view of the magnetic head device according to the modification of the fifth embodiment.

FIG. 24A is a plan view of a conventional magnetic head device.

FIG. 24B is a front view of the conventional magnetic head device.

FIG. 25A is a plan view of a head main body and an upper position restriction member of the conventional magnetic head device.

FIG. 25B is a cross-sectional view of the head main body and the upper position restriction member of the conventional magnetic head device, taken along a plane parallel to the front surface thereof.

FIG. 25C is a right side view of the head main body and the upper position restriction member of the conventional magnetic head device.

FIG. 26 is a front view of the conventional magnetic head device at the first position.

FIG. 27 is a front view of the conventional magnetic head device at the second position.

### DESCRIPTION OF THE PREFERRED EMBODIMENTS

Hereinafter, a magnetic head device and a magneto-optical disc apparatus according to the present invention will be described by way of embodiments with reference to the attached drawings.

In the following embodiments, the information recording medium is a magneto-optical disc; namely, a magnetic head device according to the present invention is used in a magneto-optical disc apparatus. The present invention is not limited to this. The information recording medium may be a magnetic disc used as a flexible disc or a hard disc, and a magnetic head apparatus according to the present invention may be used for a magnetic disc apparatus.

### Embodiment 1

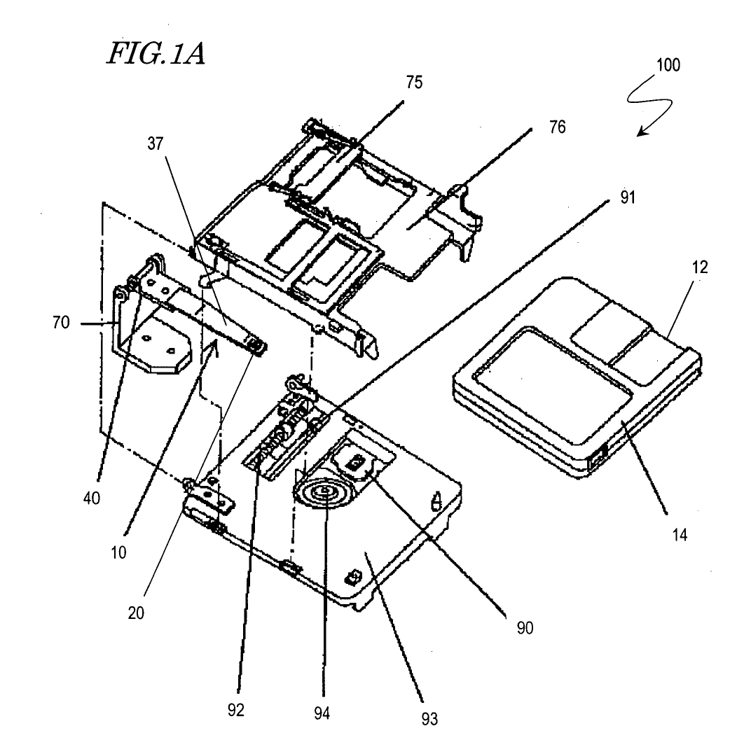

With reference to FIGS. 1A through 11, a magneto-optical disc apparatus 100 and a magnetic head device 10 according to a first embodiment of the present invention will be described. As shown in FIG. 1A, the magneto-optical disc apparatus 100 includes the magnetic head device 10 and an optical head device 90. A magneto-optical disc 12 is mountable on the magneto-optical disc apparatus 100. The magneto-optical disc 12 includes a plurality of layers having a magneto-optical recording layer and is accommodated in a cartridge 14. A tightening member 70 is provided for tightening the magnetic head device 10 and the optical head device 90. A fixing plate 40 of the magnetic head device 10 is pivotably attached to the tightening member 70 via, for example, a shaft or a spring. A lifting mechanism 75 is provided between the magnetic head device 10 and the magneto-optical disc 12, and one end of the lifting mechanism 75 is curved. When the lifting mechanism 75 pivots in a direction of approaching the magneto-optical disc 12, the lifting mechanism 75 does not contact a supporting member 37 of the magnetic head device 10. Thus, a head main body 20 and the supporting member 37 both of the magnetic head device 10 approach the magneto-optical disc 12. When the lifting mechanism 75 pivots in a direction of separating from the magneto-optical disc 12, the lifting mechanism 75 contacts the supporting member 37 of the magnetic head device 10. Thus, the head main body 20 and the supporting member 37 are separated from the magneto-optical disc 12. The optical head device 90 is movable in a radial direction of the magneto-optical disc 12 with respect to a base 93 by a shaft 91 and a screw shaft 92. The magneto-optical disc 12, which is accommodated in the cartridge 14, is inserted into a holder mechanism 76 and mounted on a spindle motor 94 attached to the base 93.

FIG. 1B is a perspective view of the magneto-optical disc apparatus 100 having the magneto-optical disc 12 mounted thereon. As shown in FIG. 1B, the cartridge 14 has an opening 16 for exposing both of two surfaces of a part of the magneto-optical disc 12 and a shutter (not shown) movable so as to open or close the opening 16. A main surface of the two surfaces of the magneto-optical disc 12 will be referred to as a “recording/reproduction surface”.

The tightening member 70 includes an angle 71 formed by bending a sheet metal, a shaft 72, a spring 73, and a pivotable base 74. The pivotable base 74 is pivotably attached to the shaft 72. The fixing plate 40 of the magnetic head device 10 is fixed to the pivotable base 74 by means of, for example, bonding, welding, or screwing. Since the tightening member 70 is fixed to the optical head device 90 (see FIG. 1A), the fixing plate 40 is fixed to the optical head device 90 via the tightening member 70. The pivotable base 74 is forced in the −Z direction by the spring 73, and a positioning member obtained by extending the pivotable base 74 in the −X direction contacts a receiving member obtained by extending the angle 71 in the −Y direction. Thus, the position of the fixing plate 40 in the Z directions, i.e., the level of the fixing plate 40, is determined. The lifting mechanism 75 acts as a magnetic head elevation device for moving up and down a magnetic head 18 of the magnetic head device 10. For recording information on the magneto-optical disc 12, the head main body 20 of the magnetic head device 10 goes into the opening 16 of the cartridge 14 which is in the open state.

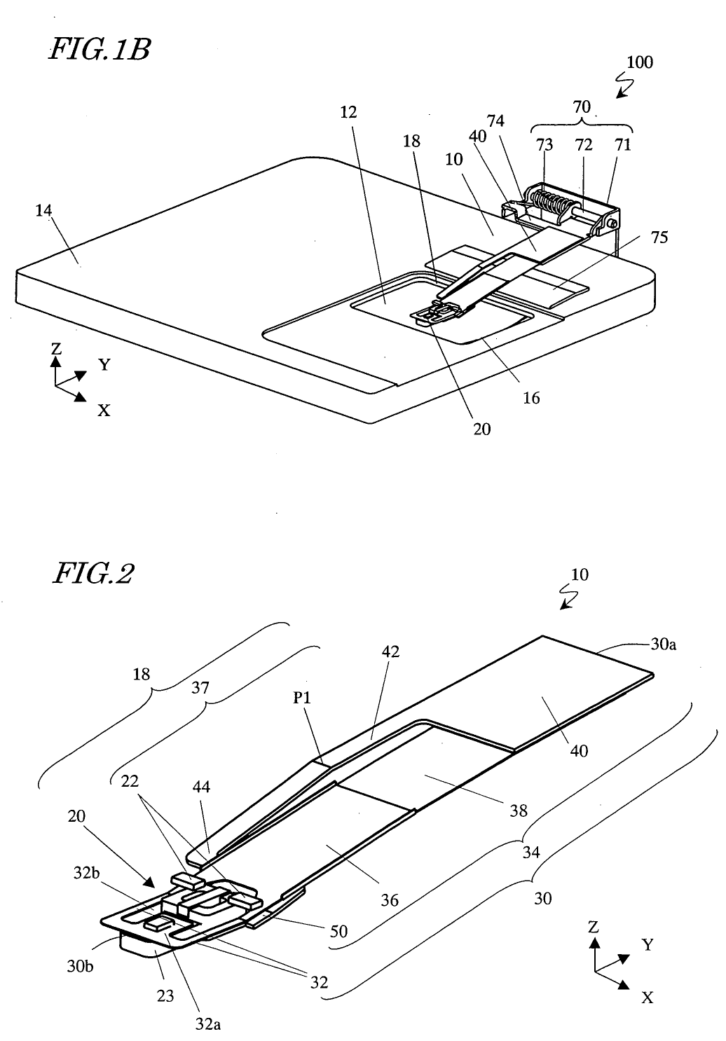

With reference to FIGS. 2 through 4, an exemplary structure of the magnetic head device 10 according to the first embodiment will be described. As shown in FIG. 2, the magnetic head device 10 includes the head main body 20 for applying a magnetic field to the magneto-optical disc 12 (see FIGS. 1A and 1B), a connecting member 30, a first position restriction member 22 provided at the head main body 20 and a second position restriction member 50. The connecting member 30 includes a main part 34 and an elastic part 32. The elastic part 32 supports the head main body 20 such that the head main body 20 is swingable. The head main body 20 is attached to the elastic part 32, which is highly elastic, and is swingable with respect to the elastic part 32 with the limitation of being supported by the elastic part 32. The structure of the head main body 20 will be described in more detail later with reference to FIG. 4. The head main body 20 includes a slidable body 23 which is slidable in contact with, or floatable at a very fine distance from, the magneto-optical disc 12. In this embodiment, the slidable body 23 is slidable in contact with the magneto-optical disc 12.

The connecting member 30 extends in the Y directions, and has a fixed end 30a and a free end 30b. The main part 34 and the elastic part 32 of the connecting member 30 are connected to each other. The main part 34 is provided on the side of the fixed end 30a, and the elastic part 32 is provided on the side of the free end 30b. The main part 34 includes a rigid part 36, an elastic part 38, the fixing plate 40, and an arm member 42.

The fixing plate 40 is formed of a metal material, and fixes the magnetic head 18. The magnetic head 18 includes the head main body 20 and the supporting member 37 for pressing the head main body 20 to the surface of the magneto-optical disc 12. The supporting member 37 is formed of a thin spring plate formed of, for example, stainless steel or phosphorus bronze. The head main body 20 is attached to one end of the supporting member 37 by means of, for example, bonding or fusion. The other end of the supporting member 37 is fixed to the fixing plate 40 by means of, for example, electric welding or laser welding.

The elastic part 38 provided adjacent to the fixing plate 40, the rigid part 36 connected to the elastic part 38, and the elastic part 32 connected to the rigid part 36 are formed of the supporting member 37. The supporting member 37 is bent in the elastic part 32. In the following description, the elastic part 38 will be referred to as a “first elastic part 38”, and the elastic part 32 will be referred to as a “second elastic part 32”. The rigid part 36 is bent to have side walls, and acts as a rigid body for the first elastic part 38 and the second elastic part 32. The second elastic part 32 is branched into two portions, and the two branched portions are connected to each other at tips thereof. A gimbal 32a is provided at the connected tip of the second elastic part 32. The second elastic part 32 has an opening 32b. The head main body 20 is attached to the gimbal 32a and is located in the opening 32b of the second elastic part 32. The head main body 20 is supported by the second elastic part 32 by means of, for example, bonding or fusion so as to be swingable. The first elastic part 38 acts to allow the head main body 20 to follow the vibration of the surface of the magneto-optical disc 12, and the second elastic part 32 acts to allow the head main body 20 to follow the tilt of the magneto-optical disc 12.

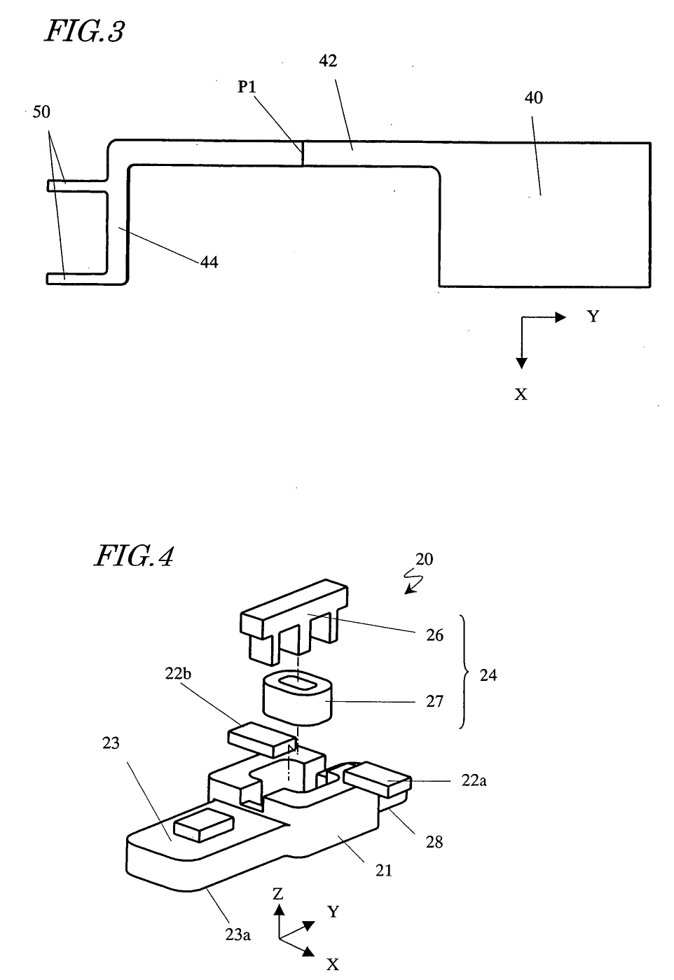

As shown in FIG. 3, the arm member 42 extending in the −Y direction is connected to the fixing plate 40 to be in the same plane therewith. The position restriction member 44 extending in the +X direction is connected to one end of the arm member 42, which is the tip in the −Y direction. The position restriction member 44 is connected to the second position restriction member 50 extending in the −Y direction. In this manner, the second position restriction member 50 is connected to the arm member 42 via the position restriction member 44.

Referring back to FIG. 2, the arm member 42 is bent along line P1 such that the second position restriction member 50 connected to the arm member 42 is positioned farther in the −Z direction than the second elastic part 32. The second position restriction member 50 is located so as to face the first position restriction member 22 with the second elastic part 32 interposed therebetween. The position restriction member 44 restricts the position of the rigid part 36 in the −Z direction. Hereinafter, the position restriction member 44 will be referred to as a “third position restriction member 44”.

As shown in FIG. 4, the head main body 20 includes amounting member 21, the slidable body 23 attached to the mounting member 21, and a magnetic head element 24 accommodated in the mounting member 21. The magnetic head element 24 applies a magnetic field. The upper position restriction member 22 includes two upper position restriction portions (i.e., upper position restriction portions 22a and 22b). The upper position restriction portion 22a extends from the mounting member 21 in +X direction, and the upper position restriction portion 22b extends from the mounting member 21 in the −X direction. The upper position restriction member 22 is integrally molded with the mounting member 21 of a resin material. The slidable body 23 is integrally attached to the mounting member 21 by, for example, an adhesive, or is integrally molded with the mounting member 21 of a resin material. The slidable body 23 is formed of a resin material having a high slidability, for example, polyphenylene sulfide or a liquid crystal polymer. The slidable body 23 has a slidable portion 23a which is slidable in contact with the magneto-optical disc 12. The slidable portion 23a is provided such that the slidable body 23 can stably contact the magneto-optical disc 12. The lower position restriction member 28, which extends in the +Y direction, is attached to the mounting member 21. Hereinafter, the lower position restriction member 28 will be referred to as a “fourth position restriction member 28”.

The magnetic head element 24 includes a magnetic core 26 and a coil 27. As shown in FIG. 4, the magnetic core 26 has generally E-shaped, and is formed of a soft magnetic material such as, for example, sintered ferrite. The coil 27 is formed by winding a conductive line. The magnetic core 26 is attached to the coil 27 such that the coil 27 surrounds the central magnetic pole of the magnetic core 26 having the generally E shape. Both of two ends of the coil 27 are fixed to an FPC (not shown) by soldering. The coil 27 is electrically connected to the FPC by the solder, and the electric current from the FPC flows through the coil 27. The electric current is modulated in accordance with the signal to be recorded. By the modulated electric current flowing through the coil 27, a modulated magnetic field is applied to the magneto-optical disc 12 from the central magnetic pole of the magnetic core 26.

Referring back to FIG. 2 again, the first position restriction member 22 is provided at the head main body 20 so as to contact the second elastic part 32 when the head main body 20 moves in the −Z direction. The second position restriction member 50 is connected to the third position restriction member 44 so as to restrict the position of the first position restriction member 22 provided at the head main body 20 when the head main body 20 moves in the −Z direction.

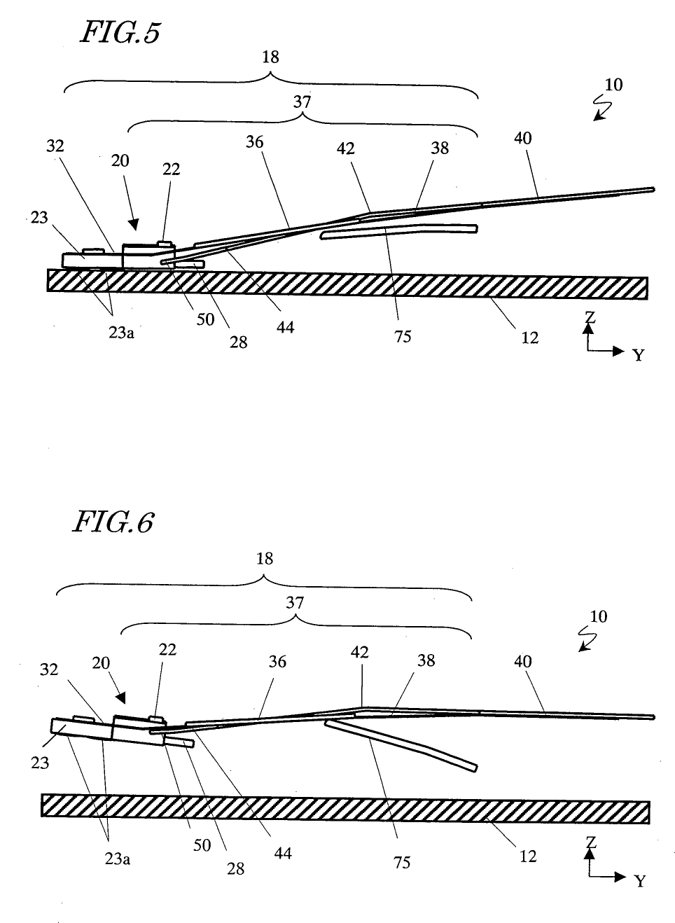

Hereinafter, with reference to FIGS. 5 and 6, operations of the magnetic head device 10 for recording information on the magneto-optical disc 12 and for reproducing information recorded on the magneto-optical disc 12 will be described.

As shown in FIG. 5, for recording information on the magneto-optical disc 12, the magnetic head device 10 moves from the second position to the first position. At this point, a lifting mechanism 75 pivots in a direction of separating from the supporting member 37 and approaching the magneto-optical disc 12. Therefore, the head main body 20 moves to a position close to the magneto-optical disc 12. The supporting member 37 supplies the head main body 20 with a force in a direction of pressing the head main body 20 to the magneto-optical disc 12. Thus, the head main body 20 can be slide in contact with the rotating magneto-optical disc 12.

As shown in FIG. 6, for reproducing information recorded on the magneto-optical disc 12, the magnetic head device 10 moves from the first position to the second position. At this point, the lifting mechanism 75 pivots in a direction of separating from the magneto-optical disc 12, and contacts the supporting member 37 and the arm member 42 to lift the supporting member 37 and the arm member 42. Therefore, the head main body 20 is separated from the magneto-optical disc 12. At this point, the third position restriction member 44 is in contact with the rigid part 36. In FIGS. 5 and 6, the cartridge 14 (see FIGS. 1A and 1B) for accommodating the magneto-optical disc 12 is omitted.

A cartridge for accommodating a magneto-optical disc specifically produced only for reproduction does not have the opening 16 (FIG. 1B). Therefore, the magnetic head device 10 is structured such that when the magnetic head device 10 is at the second position, the head main body 20 is separated from the magneto-optical disc 12 to a position where the head main body 20 does not contact the cartridge 14.

Now, the operation of the magnetic head device 10 when receiving a strong impact will be described.

When the magnetic head device 10 receives a strong impact in the −Z direction, the rigid part 36 approaches and contacts the third position restriction member 44. Thus, the position of the rigid part 36 is restricted. In this manner, the first elastic part 38 is prevented from being plastically deformed by the third position restriction member 44.

When the magnetic head device 10 receives an impact in the −Z direction, the first position restriction member 22 provided at the head main body 20 approaches and contacts the second elastic part 32 and thus restricts the position of the head main body 20. Even when the first position restriction member 22 contacts and thus elastically deforms the second elastic part 32 and as a result, the first position restriction member 22 and the second elastic part 32 move in the −Z direction, the second elastic part 32 is prevented from being plastically deformed. The reason is that the second position restriction member 50 restricts the position of the first position restriction member 22 and so restricts the position of the head main body 20 providing with the first position restriction member 22. The second position restriction member 50 restricts the position of the first position restriction member 22 by contacting the second elastic part 32, which is in contact with the first position restriction member 22.

When the magnetic head device 10 receives an impact in the +Z direction, the fourth (or lower) position restriction member 28 provided at the head main body 20 approaches and contacts the rigid part 36. The fourth position restriction member 28 restricts the position of the head main body 20 by contacting the rigid part 36, and thus prevents the second elastic part 32 for supporting the head main body 20 from being plastically deformed.

The external housing (not shown) of the magneto-optical disc apparatus 100 is located so as to face the magneto-optical disc 12 with the magnetic head device 10 interposed therebetween. Owing to such an arrangement, when the magnetic head device 10 at the second position receives an impact in the +Z direction, the magnetic head device 10 moves in the +Z direction and contacts the external housing, and thus restricts the position of the head main body 20.

As described above, the second position restriction member 50 is connected to the arm member 42 via the third position restriction member 44, and the second position restriction member 50 pivots in the Z directions together with the fixing plate 40 connected to the arm member 42. As shown in FIG. 5, when the magnetic head device 10 is at the first position, the second position restriction member 50 does not contact the second elastic part 32. Therefore, the head main body 20 can follow the magneto-optical disc 12 in a satisfactory manner by the second elastic part 32. This realizes high speed rotation of the magneto-optical disc 12 and thus high speed information recording.

The fixing plate 40 is formed of a metal material, and the second position restriction member 50 is connected to the fixing plate 40 via the third position restriction member 44 and the arm member 42. Accordingly, when the second position restriction member 50 contacts the second elastic part 32 which is in contact with the first position restriction member 22, the second position restriction member 50 can, with certainty, give a force to the head main body 20 providing with the first position restriction member 22 via the second elastic part 32. Thus, the second elastic part 32 for supporting the head main body 20 can be more certainly prevented from being plastically deformed.

As described above, the magnetic head device 10 according to the first embodiment, even when receiving a strong impact by falling or transportation, prevents the second elastic part 32 from being plastically deformed as follows. When the magnetic head device 10 receives a strong impact by falling or transportation and as a result, the head main body 20 receives a strong impact in the −Z direction, the first position restriction member 22 provided at the head main body 20 contacts the second elastic part 32 and thus restricts the position of the head main body 20, and in addition, the second position restriction member 50 restricts the position of the first position restriction member 22, which is in contact with the second elastic part 32. Thus, the second elastic part 32 can be prevented from being plastically deformed by the second position restriction member 50.

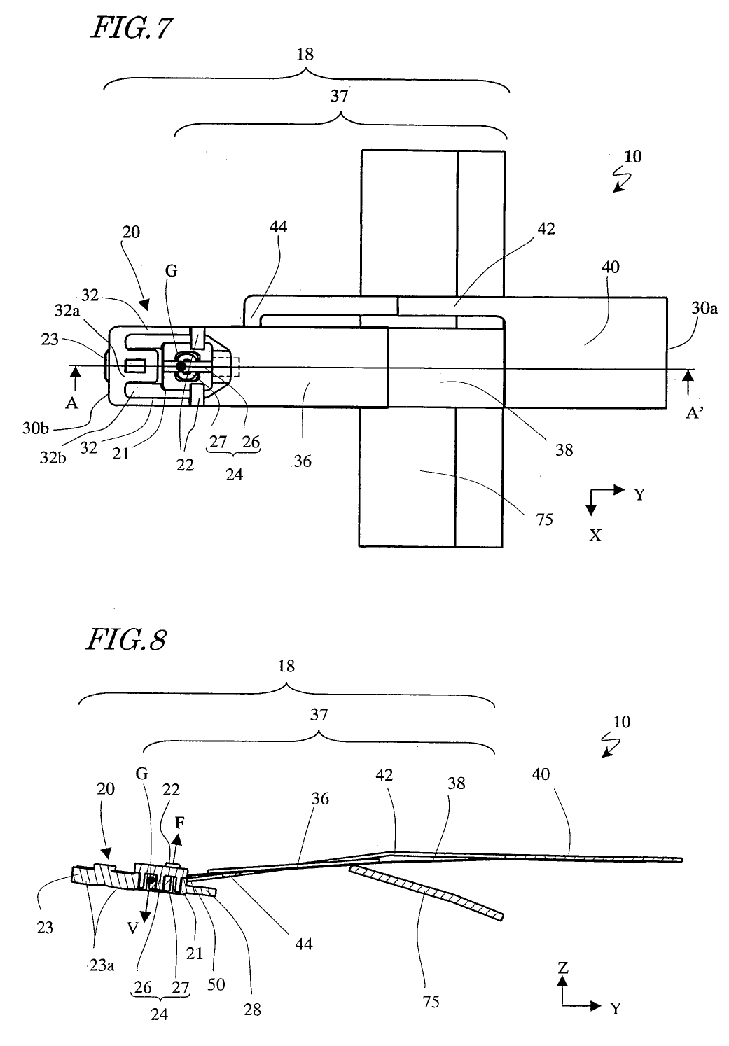

Preferably, as shown in FIGS. 7 and 8, the first position restriction member 22 is located at an area of the head main body 20 which is other than the area of the head main body 20 closest to the fixed end 30a of the connecting member 30. In other words, the first position restriction member 22 is attached to the mounting member 21 of the head main body 20 at an area other than the area indicated by the dashed line in FIG. 7 (the area encompassing the end of the mounting member 21 in the +Y direction). In this case, the first position restriction member 22 is provided in the vicinity of the center of gravity G of the head main body 20. When the first position restriction member 22 contacts the second elastic part 32, the head main body 20 receives a force, at the first position restriction member 22, in the opposite direction to the moving direction of the head main body 20. If the first position restriction member 22 is located at the area of the head main body 20 which is closest to the fixed end 30a of the connecting member 30 (the area indicated with the dashed line in FIG. 7), the first position restriction member 22, which is provided at the head main body 20 for receiving the force, is far from the center of gravity G of the head main body 20. When the first position restriction member 22 contacts the second elastic part 32 in this state, the force received by the head main body 20 does not much contribute to suppressing the motion of the center of gravity G of the head main body 20. As a result, the head main body 20 significantly vibrates. Referring to FIG. 8, when the first position restriction member 22, which is provided at the head main body 20 for receiving the force, is located in the vicinity of the center of gravity G of the head main body 20, a majority of force F received by the first position restriction member 22 contributes to suppressing motion V of the head main body 20. Therefore, even when the first position restriction member 22 contacts the second elastic part 32, the head main body 20 does not significantly vibrate. More specifically, it is preferable that the first position restriction member 22 is located in the vicinity of the magnetic head element 24. The reason is that the magnetic core 26 and the coil 27 included in the magnetic head element 24 are formed of a metal material and thus have a high specific gravity, and the center of gravity G of the head main body 20 exists inside or in the vicinity of the magnetic head element 24. As described above, it is preferable to locate the first position restriction member 22 at an area of the head main body 20 which is other than the area closest to the fixed end 30a of the connecting member 30. For example, as shown in FIG. 8, it is preferable to locate the first position restriction member 22 at a side part of the head main body 20 in a substantially parallel direction to the Y directions.

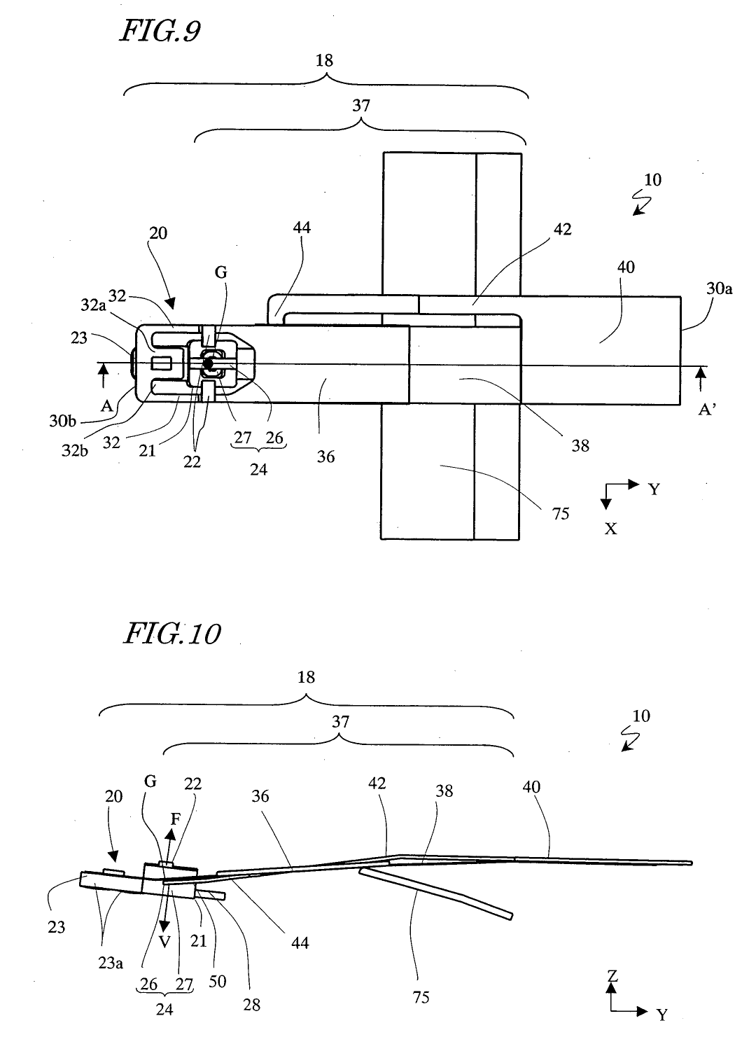

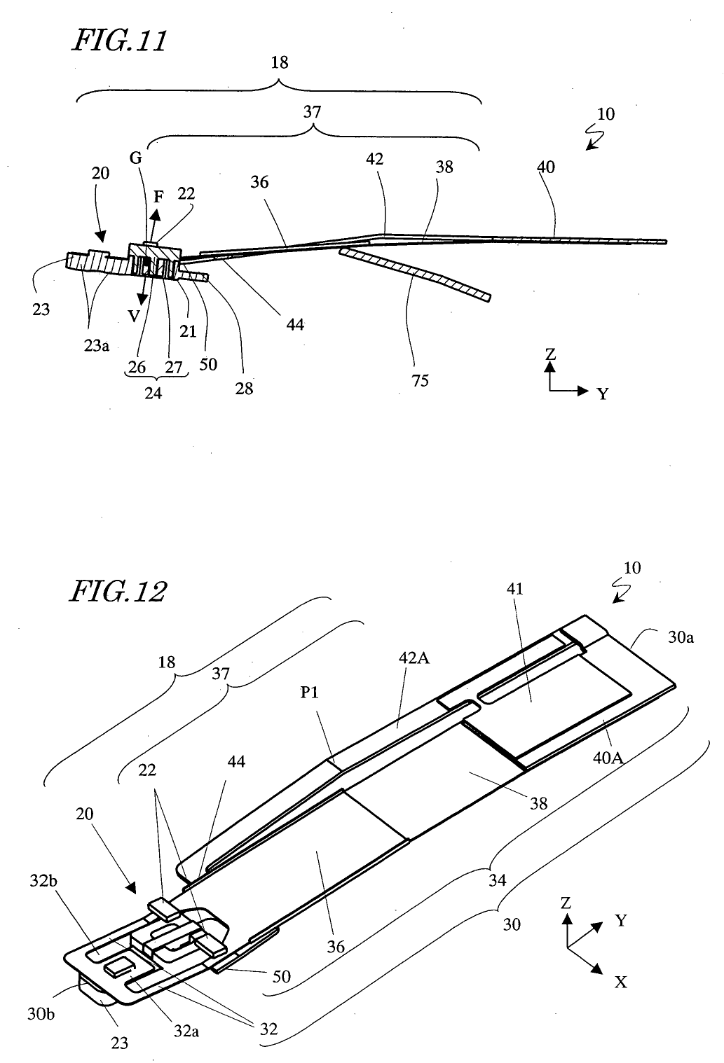

More preferably, as shown in FIGS. 9 through 11, the first position restriction member 22 is provided at the head main body 20 such that when the first position restriction member 22 contacts the second elastic part 32, a force in the opposite direction to the moving direction of the center of gravity G of the head main body 20 is given to the center of gravity G. Referring to FIGS. 10 and 11, when the first position restriction member 22, which receives the force applied to the head main body 20, is located on the locus of the center of gravity G of the head main body 20, the entirety of force F received by the first position restriction member 22 contributes to suppressing motion V of the head main body 20. In an ideal case, the head main body 20 does not vibrate. Therefore, it is preferable to locate the first position restriction member 22 at the head main body 20 such that a force in the opposite direction to the moving direction of the center of gravity G of the head main body 20 is given to the center of gravity G.

As described above, by providing the first position restriction member 22 so as to be in the vicinity of the center of gravity G of the head main body 20, the head main body 20 is prevented from vibrating when the first position restriction member 22 contacts the second elastic part 32. Thus, the reliability of the magnetic head device 10 against the impact can be improved.

In the above embodiment, the supporting member 37 includes two elastic parts (i.e., the first elastic part 38 and the second elastic part 32). The present invention is not limited to such a structure. The supporting member 37 does not need to include the first elastic part 38.

As described above, in the magnetic head device 10 according to the first embodiment, when the head main body 20 receives an impact in the −Z direction, the second position restriction member 50 restricts the position of the head main body 20 by restricting the position of the first position restriction member 22 which is in contact with the second elastic part 32. Therefore, the second elastic part 32 is prevented from being plastically deformed. Thus, the reliability of the magnetic head device 10 against the impact can be improved.

When the magnetic head device 10 is at the first position, the second position restriction member 50 does not restrict the position of the head main body 20. Therefore, the head main body 20 can follow the magneto-optical disc 12 in a satisfactory manner. As a result, high speed rotation of the magneto-optical disc 12, and thus high speed information recording, are realized.

In the above embodiment, the arm member 42 is connected to the fixing plate 40 to be in the same plane therewith. The present invention is not limited to such a structure.

### Embodiment 2

With reference to FIGS. 12 and 13, a magnetic head device 10 according to a second embodiment of the present invention will be described. In FIGS. 12 and 13, substantially identical elements with those described above bear identical reference numerals therewith and detailed descriptions thereof will be omitted. In the magnetic head device 10 according to the second embodiment, a pivotable arm member 42A is freely pivotable with respect to the fixing plate 40A.

As shown in FIG. 12, the fixing plate 40A is formed of a stainless steel plate. The supporting member 37 is fixed to the fixing plate 40A by means of, for example, bonding or welding.

A leaf spring 41 is formed of a metal plate formed of phosphorus bronze or stainless steel. The leaf spring 41 has a hinge and is fixed to both the fixing plate 40A and the pivotable arm member 42A by welding.

The pivotable arm member 42A extends in the Y directions. The pivotable arm member 42A is pivotable about the hinge of the leaf spring 41 with respect to the fixing plate 40A. One of two ends of the pivotable arm member 42A which is in the −Y direction is pressed toward the magneto-optical disc 12 by the leaf spring 41. The other end of the pivotable arm member 42A which is in the +Y direction contacts the fixing plate 40A, and thus the pivotable arm member 42A is positioned. The end of the pivotable arm member 42A in the −Y direction is connected to the third position restriction member 44 extending in the +X direction. The third position restriction member 44 is connected to the second position restriction member 50 extending in the −Y direction. In this manner, the second position restriction member 50 is connected to the pivotable arm member 42A via the third position restriction member 44. The pivotable arm member 42A is bent along line P1 such that the second position restriction member 50 connected to the pivotable arm member 42A is positioned farther in the −Z direction than the second elastic part 32.

Referring to FIG. 13, when the magnetic head device 10 is at the second position, the lifting mechanism 75 pivots in a direction of separating from the magneto-optical disc 12, and contacts the supporting member 37 and the pivotable arm member 42A to lift the supporting member 37 and the pivotable arm member 42A. Therefore, the head main body 20 is separated from the magneto-optical disc 12. At this point, the third position restriction member 44 is in contact with the rigid part 36.

In the magnetic head device 10 according to the second embodiment, the pivotable arm member 42A is structured to pivot with respect to the fixing plate 40A. Owing to such a structure, when the magnetic head device 10 moves from the first position to the second position, the pivotable arm member 42A can pivot about the hinge of the leaf spring 41 or the vicinity thereof, not the shaft 72 (see FIG. 1A). Therefore, the distance between the magneto-optical disc 12 and line P1 along which the pivotable arm member 42A is bent can be shortened.

With the magnetic head device 10 according to the second embodiment, as described in the first embodiment with reference to FIGS. 7 through 11, the first position restriction member 22 is preferably located at an area of the head main body 20 which is other than the area closest to the fixed end 30a of the connecting member 30. More preferably, the first position restriction member 22 is located at the head main body 20 such that when the first position restriction member 22 contacts the second elastic part 32, a force in the opposite direction to the moving direction of the center of gravity G of the head main body 20 is given to the center of gravity G.

Owing to the above-described structure, the magnetic head device 10 according to the second embodiment has a reduced thickness.

### Embodiment 3

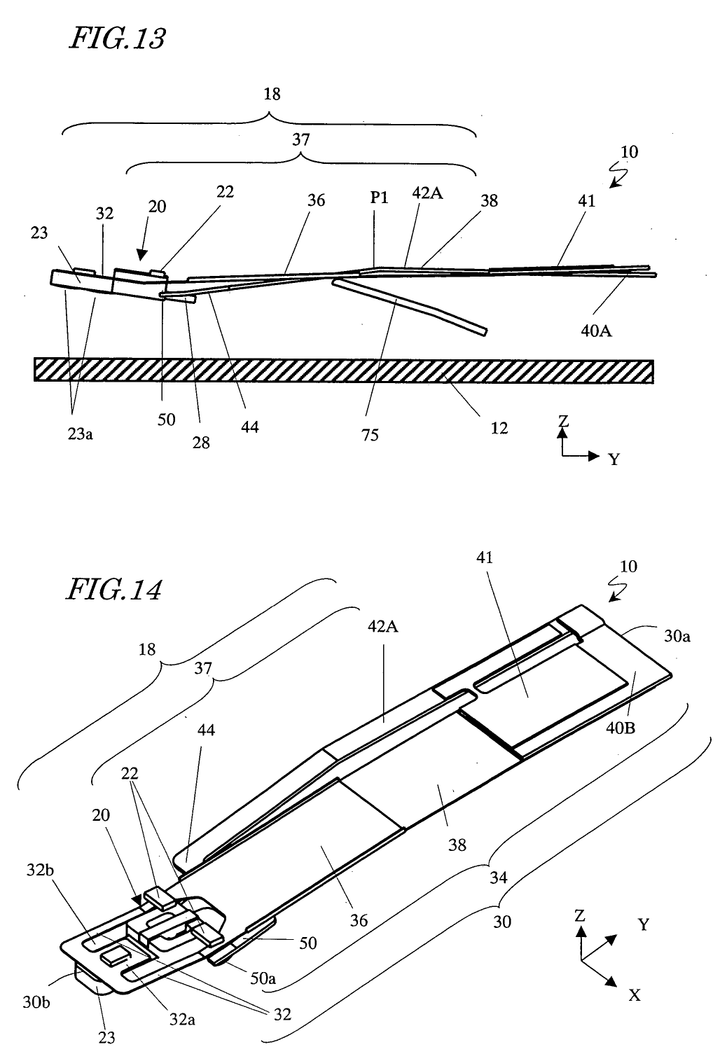

With reference to FIGS. 14 through 16, a magnetic head device 10 according to a third embodiment of the present invention will be described. In FIGS. 14 through 16, substantially identical elements with those described above bear identical reference numerals therewith and detailed descriptions thereof will be omitted.

As shown in FIG. 14, the pivotable arm member 42A extends in the Y directions, and is formed of a metal material such as, for example, stainless steel or iron. One of two ends of the pivotable arm member 42A which is in the −Y direction is connected to the third position restriction member 44 extending in the +X direction. The third position restriction member 44 is connected to the second position restriction member 50 extending in the −Y direction.

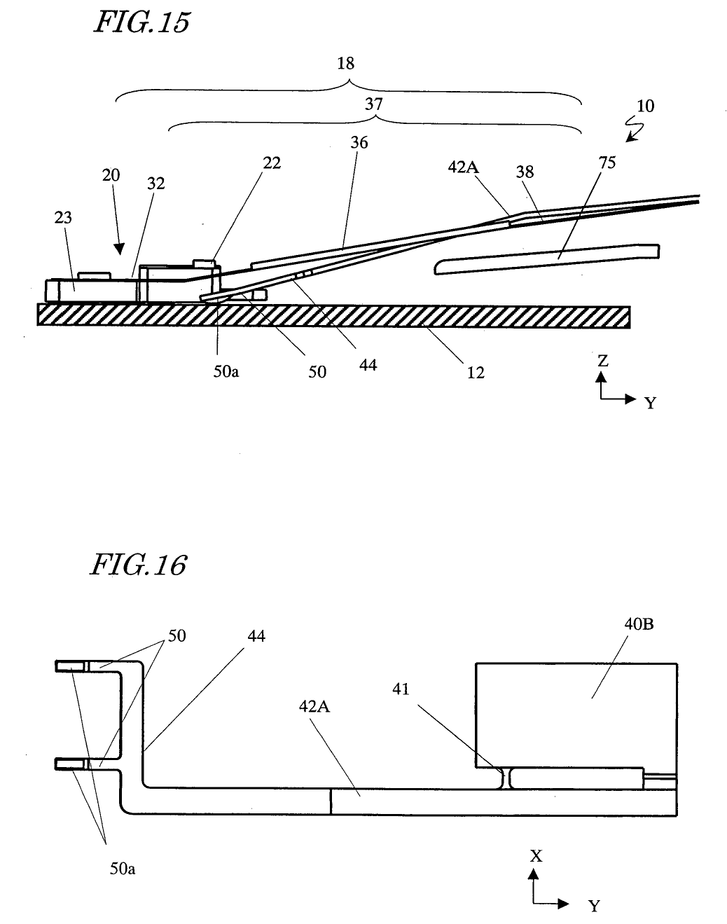

As shown in FIG. 16, slidable projections 50a are provided on end surfaces of the second position restriction member 50 which face the magneto-optical disc 12. The slidable projections 50a are integrally formed with the second position restriction member 50 by means of, for example, outsert molding. The slidable projections 50a are formed of a resin material having a high slidability, for example, polyphenylene sulfide or a liquid crystal polymer. Each slidable projection 50a has the shape of a column having a substantially semicircular cross-section. The surface of each slidable projection 50a facing the magneto-optical disc 12 is curved.

The magnetic head device 10 according to the third embodiment is different from the magnetic head device 10 according to the second embodiment in that the former includes the slidable projections 50a formed of a highly slidable resin material on the surfaces of the second position restriction member 50 which face the magneto-optical disc 12.

Referring to FIG. 15, when the magnetic head device 10 is at the first position, the lifting mechanism 75 pivots in a direction of separating from the pivotable arm member 42A and the supporting member 37 and approaching the magneto-optical disc 12. At this point, the head main body 20 moves toward, and contacts, the magneto-optical disc 12. Since the supporting member 37 supplies the head main body 20 in a direction of pressing the head main body 20 to the magneto-optical disc 12, the head main body 20 can slide in contact with the rotating magneto-optical disc 12.

The pivotable arm member 42A is supplied by the leaf spring 41 with a force in a direction of being pressed to the magneto-optical disc 12. Therefore, the slidable projections 50a provided on the ends of the second position restriction member 50 slide in contact with the rotating magneto-optical disc 12.

When the magneto-optical disc 12 vibrates in the state where the magnetic head device 10 is at the first position and the magneto-optical disc 12 is rotating, the first position restriction member 22 provided at the head main body 20 and the second elastic part 32 for supporting the first position restriction member 22 swing in the Z directions. In the magnetic head device 10 according to the third embodiment, the slidable projections 50a provided on the second position restriction member 50 slide in contact with the magneto-optical disc 12. Therefore, the second position restriction member 50 swing in the Z directions, like the first position restriction member 22 and the second elastic part 32. Therefore, in the magnetic head device 10 according to the third embodiment, the distance between the second position restriction member 50 and the second elastic part 32 does not change or changes by a very small amount. Therefore, the second elastic part 32 is prevented from contacting the second position restriction member 50 while the magnetic head device 10 is recording information. This realizes high speed rotation of the magneto-optical disc 12 and thus high speed recording information. In addition, the second position restriction member 50 can be located in the vicinity of the second elastic part 32 and thus the magnetic head device 10 can be reduced in thickness.

In the above embodiment, the pivotable arm member 42A is formed of a metal material. Alternatively, the pivotable arm member 42A may be formed of the same resin as that of the slidable projections 50a or may be integrally formed with the slidable projections 50a

With the magnetic head device 10 according to the third embodiment, as described in the first embodiment with reference to FIGS. 7 through 11, the first position restriction member 22 is preferably located at an area of the head main body 20 which is other than the area closest to the fixed end 30a of the connecting member 30. More preferably, the first position restriction member 22 is located at the head main body 20 such that when the first position restriction member 22 contacts the second elastic part 32, a force in the opposite direction to the moving direction of the center of gravity G of the head main body 20 is given to the center of gravity G.

As described above, in the magnetic head device 10 according to the third embodiment, the second elastic part 32 is prevented from contacting the second position restriction member 50 while the magnetic head device 10 is recording information. Therefore, high speed rotation of the magneto-optical disc 12, and thus high speed recording information, are realized. In addition, the magnetic head device 10 can be reduced in thickness.

### Embodiment 4

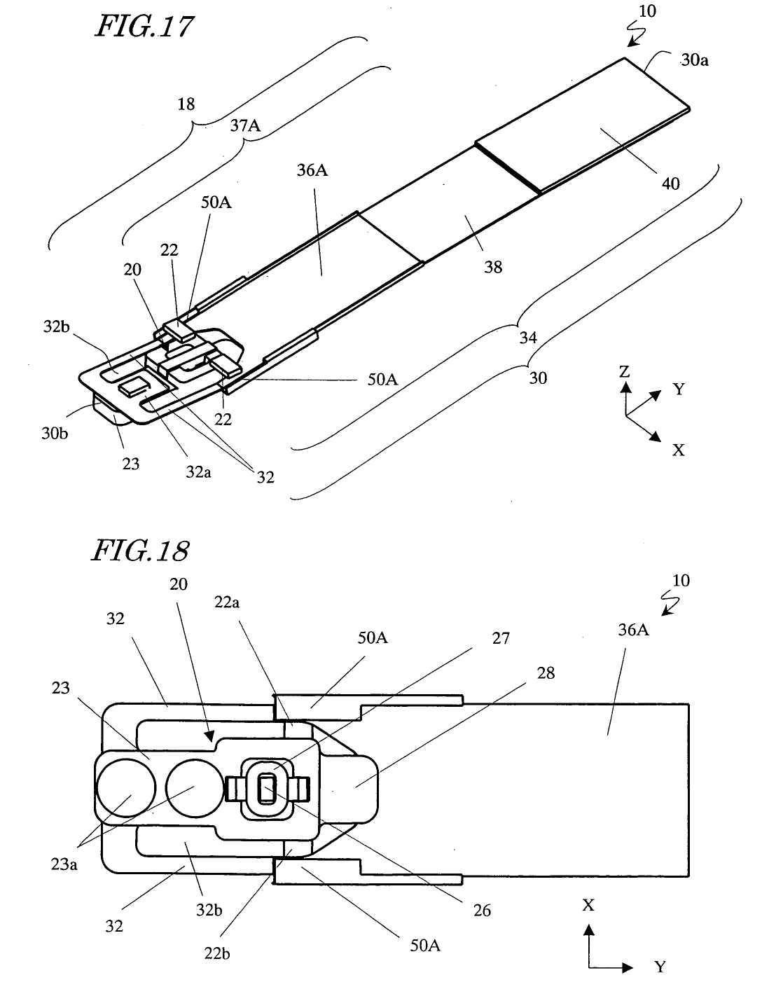

With reference to FIGS. 17 through 19, a magnetic head device 10 according to a fourth embodiment of the present invention will be described. In FIGS. 17 through 19, substantially identical elements with those described above bear identical reference numerals therewith and detailed descriptions thereof will be omitted.

The magnetic head device 10 according to the fourth embodiment is different from the magnetic head device 10 according to the previous embodiments in that the former has a second position restriction member 50A provided at a rigid part 36A.

As shown in FIG. 17, the second position restriction member 50A is formed by bending side walls of the rigid part 36A. The second position restriction member 50A faces the first position restriction member 22 with the second elastic part 32 interposed therebetween. The supporting member 37 is formed of a thin spring plate formed of, for example, stainless steel or phosphorus bronze. The first elastic part 38 provided adjacent to the fixing plate 40, the rigid part 36A connected to the first elastic part 38, and the second elastic part 32 connected to the rigid part 36A are formed of the supporting member 37. The second position restriction member 50A is formed by bending side walls of the rigid part 36A, integrally with the rigid part 36A. The second position restriction member 50A and the second elastic part 32 are away from each other by a predetermined distance.

As shown in FIG. 18, the second elastic part 32 is branched into two portions, and the two branched portions are connected to each other at tips thereof. The second elastic part 32 has an opening 32b. The head main body 20 is located in the opening 32b of the second elastic part 32, and the head main body 20 is supported by the elastic part 32 by means of, for example, bonding or fusion, so as to be swingable. The slidable body 23 of the head main body 20 has a slidable portion 23a.

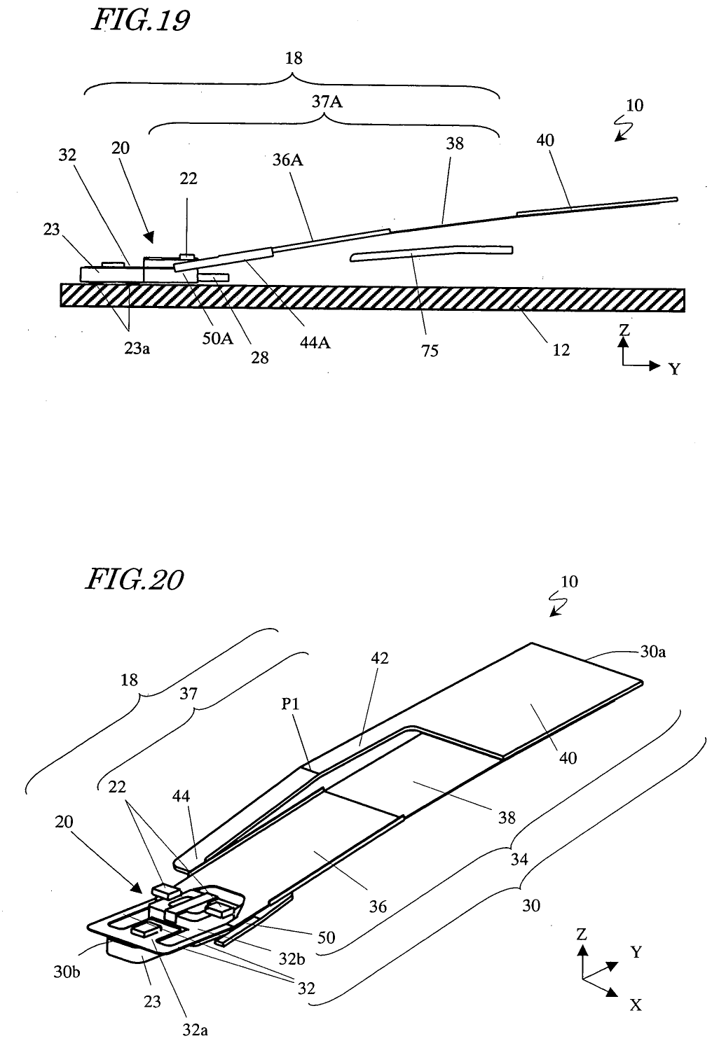

As shown in FIG. 19, when the magnetic head device 10 is at the first position, the surface of the magneto-optical disc 12 vibrates by the rotation of the magneto-optical disc 12. In the magnetic head device 10 according to the fourth embodiment, the second position restriction member 50A is integrally formed with the supporting member 37. Therefore, when the first position restriction member 22 provided at the head main body 20 and the second elastic part 32 for supporting the head main body 20 swing in the Z directions by the vibration of the magneto-optical disc 12, the second position restriction member 50A swings in the Z directions, like the second elastic part 32 and the first position restriction member 22. In this manner, the second elastic part 32 is prevented from contacting the second position restriction member 50A while the magnetic head device 10 is at the first position. As a result, high speed rotation of the magneto-optical disc 12, and thus high speed information recording, are realized. In addition, the second position restriction member 50A can be located in the vicinity of the second elastic part 32, which reduces the thickness of the magnetic head device 10.

The rigid part 36A is formed by bending the supporting member 37 so as to act as a rigid body for the first elastic part 38 and the second elastic part 32. The second position restriction member 50A is connected to the rigid part 36A. Accordingly, when the second position restriction member 50A contacts the second elastic part 32 which is in contact with the first position restriction member 22, the second position restriction member 50A can, with certainty, give a force to the head main body 20 providing with the first position restriction member 22 via the second elastic part 32. Thus, the second elastic part 32 for supporting the head main body 20 can be more certainly prevented from being plastically deformed.

In the above embodiment, the second position restriction member 50A is formed by bending a part of the supporting member 37. Alternatively, the second position restriction member 50A may be integrally formed with the supporting member 37 of a resin material by means of, for example, outsert molding.

With the magnetic head device 10 according to the fourth embodiment, as described in the first embodiment with reference to FIGS. 7 through 11, the first position restriction member 22 is preferably located at an area of the head main body 20 which is other than the area closest to the fixed end 30a of the connecting member 30. More preferably, the first position restriction member 22 is located at the head main body 20 such that when the first position restriction member 22 contacts the second elastic part 32, a force in the opposite direction to the moving direction of the center of gravity G of the head main body 20 is given to the center of gravity G.

As described above, in the magnetic head device 10 according to the fourth embodiment, the change in the distance between the second position restriction member 50A and the second elastic part 32, which is caused by the vibration of the magneto-optical disc 12, can be reduced. Therefore, the magnetic head device 10 can have a reduced thickness. In addition, since the second position restriction member 50A is integrally formed with the rigid part 36A, the reliability of the magnetic head device 10 against the impact can be improved without requiring an arm member. This reduces the cost of the magneto-optical disc apparatus.

In the above embodiments, the second position restriction member 50 or 50A restricts the position of the first position restriction member 22 by contacting the second elastic part 32. The present invention is not limited to such a structure. The second position restriction member 50 or 50A may restrict the position of the first position restriction member 22 by contacting at least one of the first position restriction member 22 and the second elastic part 32.

In the first through fourth embodiments, the second elastic part 32, which is in contact with the first position restriction member 22, contacts the second position restriction member 50 or 50A, and thus the position of the first position restriction member 22 and therefore the position of the head main body 20 providing with the first position restriction member 22 are restricted. In this manner, the second elastic part 32 for supporting the head main body 20 can be prevented from being plastically deformed.

### Embodiment 5

With reference to FIGS. 20 through 23, a magnetic head device 10 according to a fifth embodiment of the present invention will be described. In FIGS. 20 through 23, substantially identical elements with those described above in the first through fourth embodiments bear identical reference numerals therewith and detailed descriptions thereof will be omitted.

The magnetic head device 10 according to the fifth embodiment is different from the magnetic head device 10 according to the first through fourth embodiments in that in the former, the first position restriction member 22 contacts the second position restriction member 50 without contacting the second elastic part 32.

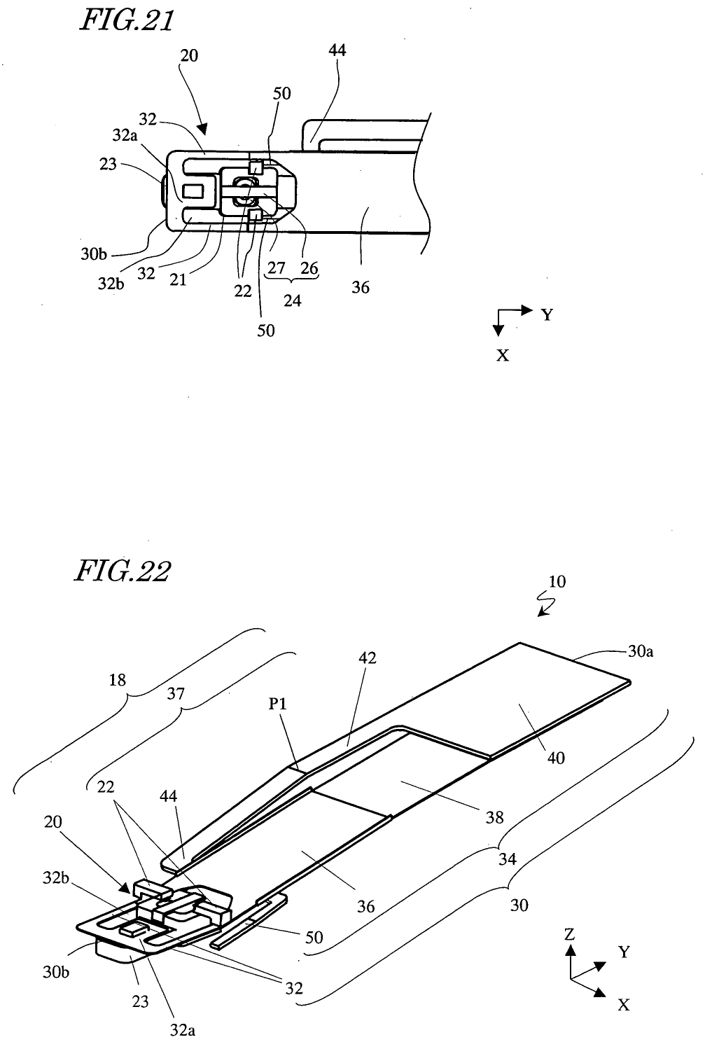

As shown in FIGS. 20 and 21, the magnetic head device 10 according to the fifth embodiment is different from the magnetic head device 10 according to the first embodiment described above with reference to FIG. 2 in that in the former, the first position restriction member 22 provided at the head main body 20 is short.

The first position restriction member 22 of the head main body 20 faces the second position restriction member 50, and the first position restriction member 22 is short. Therefore, when the head main body 20 moves in the −Z direction, the first position restriction member 22 passes through the opening 32b of the second elastic part 32 without contacting the second elastic part 32 and contacts the second position restriction member 50.

In the fifth embodiment as in the first embodiment, the fixing plate 40 is formed of a metal material, and the second position restriction member 50 is connected to the fixing plate 40 via the third position restriction member 44 and the arm member 42. Accordingly, when the second position restriction member 50 contacts the first position restriction member 22, the second position restriction member 50 can, with certainty, give a force to the head main body 20 providing with the first position restriction member 22. Thus, the second elastic part 32 for supporting the head main body 20 can be prevented from being plastically deformed.

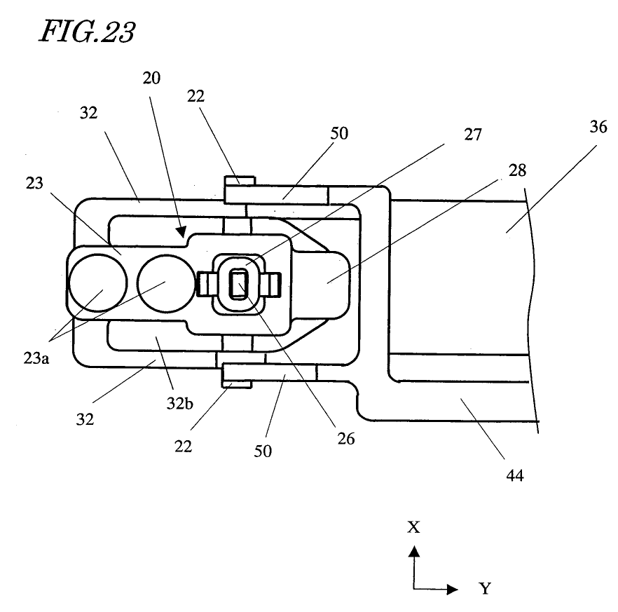

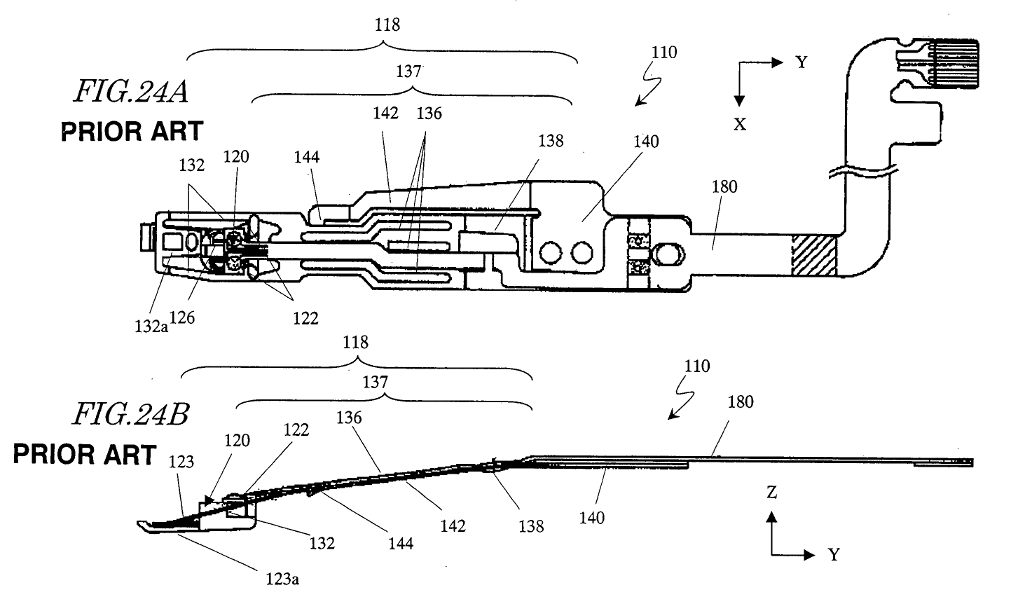

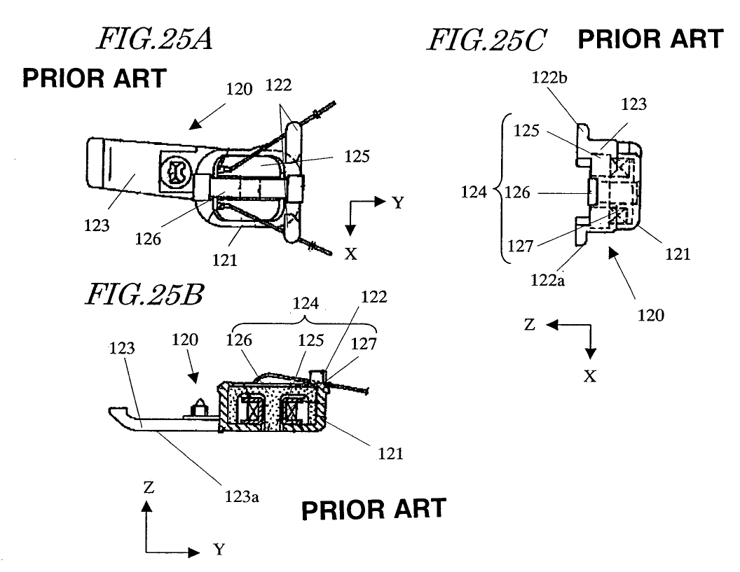

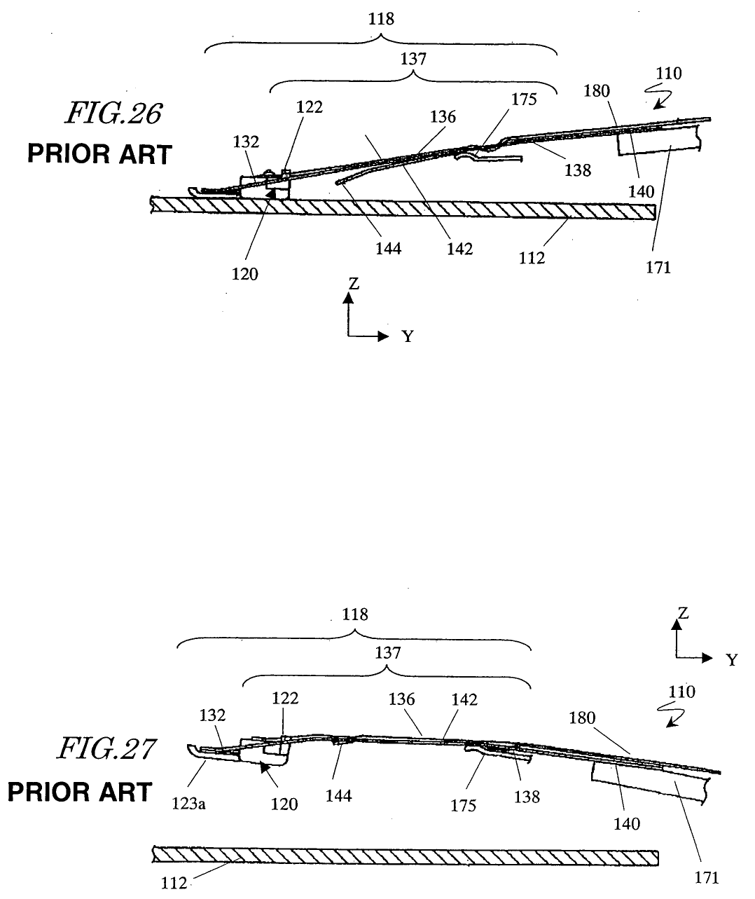

In the above embodiment, the first position restriction member 22 provided at the head main body 20 passes through the opening 32b of the second elastic part 32 to contact the second position restriction member 50, but the present invention is not limited to such a structure. FIGS. 22 and 23 show a magnetic head device 10 in a modification of the fifth embodiment of the present invention.

As shown in FIGS. 22 and 23, the magnetic head device 10 in the modification is different from the magnetic head device 10 described above with reference to FIGS. 20 and 21 in that in the former, a part of the first position restriction member 22 passes outside the second elastic part 32 to contact the second position restriction member 50.

In this modification of the fifth embodiment, the head main body 20 is located in the opening 32b of the second elastic part 32, with the first position restriction member 22 provided at the head main body 20 being provided so as to bridge over the second elastic part 32. In more detail, the first position restriction member 22 is L-shaped, and includes a first portion extending in the X direction so as to bridge over the second elastic part 32 and second portions extending in the −Z direction from tips of the first portion. The second position restriction member 50 is provided so as to face the second portions of the first position restriction member 22. When the head main body 20 moves in the −Z direction, the second portions of the first position restriction member 22 pass outside the second elastic part 32 and contact the second position restriction member 50.

In this modification also, the fixing plate 40 is formed of a metal material, and the second position restriction member 50 is connected to the fixing plate 40 via the third position restriction member 44 and the arm member 42. Accordingly, when the second position restriction member 50 contacts the first position restriction member 22, the second position restriction member 50 can, with certainty, give a force to the head main body 20 providing with the first position restriction member 22. Thus, the second elastic part 32 for supporting the head main body 20 can be prevented from being plastically deformed.

When the second portions of the first position restriction member 22 contact the second position restriction member 50, the first portion of the first position restriction member 22 may or may not contact the second elastic part 32. In either case, the second elastic part 32 for supporting the head main body 20 can be prevented from being plastically deformed.

With the magnetic head device 10 according to the fifth embodiment and the above-described modification, as described in the first embodiment with reference to FIGS. 7 through 11, the first position restriction member 22 is preferably located at an area of the head main body 20 which is other than the area closest to the fixed end 30a of the connecting member 30. More preferably, the first position restriction member 22 is located at the head main body 20 such that when the first position restriction member 22 contacts the second elastic part 32, a force in the opposite direction to the moving direction of the center of gravity G of the head main body 20 is given to the center of gravity G. In the fifth embodiment and the modification thereof, the first position restriction member 22 contacts the second position restriction member 50 without contacting the second elastic part 32. With such a structure, substantially the same effects as those described in the first embodiment with reference to FIGS. 7 through 11 are provided.

Like in the first through fourth embodiments, when the magnetic head device 10 is at the first position, the second position restriction member 50 does not restrict the position of the head main body 20. Therefore, the head main body 20 can follow the magneto-optical disc 12 in a satisfactory manner. This realizes high speed rotation of the magneto-optical disc 12 and thus high speed information recording.

The second position restriction member 50 is connected to the fixing plate 40 in the fifth embodiment and the modification thereof. Alternatively, as in the fourth embodiment described with reference to FIGS. 17 through 19, the second position restriction member 50A formed by bending the rigid part 36A may be used. In this case also, the position of the head main body 20 is restricted by the second position restriction member 50A connected to the rigid part 36A, and therefore the second elastic part 32 for supporting the head main body 20 can be prevented from being plastically deformed.

In the above embodiments, the second position restriction member 50 or 50A is connected to the fixing plate 40 or the rigid part 36A. As long as the second position restriction member 50 or 50A is connected to a higher rigidity part of the main part 34 having a higher rigidity than that of the second elastic part 32, the second elastic part 32 for supporting the head main body 20 can be prevented from being plastically deformed.

In the above embodiments, the fixing plate 40 or 40A is formed of a metal material, but the present invention is not limited to this. The fixing plate 40 or 40A may be formed by molding a resin such as, for example, polyphenylene sulfide, a liquid crystal polymer, or polycarbonate. In that case, it is preferable to add a reinforcing additive such as, for example, glass fiber or carbon fiber to the resin.

In the above embodiments, the head main body 20 includes two first position restriction portions (i.e., the first position restriction portions 22a and 22b). The present invention is not limited to such a structure. The two first position restriction portions may be integrated together.

In the above embodiments, the magnetic head device 10 provides with a head main body 20 which is slidable in contact with the magneto-optical disc 12 as an information recording medium. The present invention is not limited to such a structure. A magnetic head device according to the present invention may include a head main body which floats at substantially a constant distance from the magneto-optical disc by the rotation of the magneto-optical disc.

In the above embodiments, a magneto-optical disc is used as an exemplary information recording medium. The present invention is not limited to this. An information recording medium may be, for example, a magnetic disc used as a flexible disc or a hard disc. A magnetic head device according to the present invention may be used for a magnetic disc apparatus. A magnetic head device according to the present invention is preferably used for a magneto-optical disc apparatus in order to provide the effect of the present invention in the best manner, for the following reason. In the case where a magneto-optical disc is not mounted on a magneto-optical disc apparatus, the magnetic head device apparatus is at the second position. When the magneto-optical disc apparatus receives a strong impact in this state, the elastic part of the magnetic head device of the magneto-optical disc apparatus is significantly deformed, and thus the magnetic head device receives stronger damage. Where the magnetic head device according to the present invention is used, the reliability of the magnetic head device against the impact can be highly improved.

According to the present invention, even when the magneto-optical disc apparatus including the magnetic head device receives a strong impact by falling or transportation, the elastic part of the magnetic head device is prevented from being plastically deformed. In addition, since the second position restriction member does not contact the elastic part during information recording, high speed information recording is realized.

This application is based on Japanese Patent Applications No. 2004-098923 filed Mar. 30, 2004 and No. 2004-374520 filed Dec. 24, 2004, the entire contents of which are hereby incorporated by reference.

While the present invention has been described with respect to preferred embodiments thereof, it will be apparent to those skilled in the art that the disclosed invention may be modified in numerous ways and may assume many embodiments other than those specifically described above. Accordingly, it is intended by the appended claims to cover all modifications of the invention that fall within the true spirit and scope of the invention.

1. A magnetic head device, comprising:
a head main body for applying a magnetic field to an information recording medium;
a connecting member including a main part and an elastic part connected to the main part, the elastic part supporting the head main body such that the head main body is swingable;
a first position restriction member provided at the head main body for restricting a position of the head main body by contacting the elastic part; and
a second position restriction member for restricting a position of the head main body by restricting a position of the first position restriction member which in contact with the elastic part.

2. A magnetic head device according to claim 1, wherein the second position restriction member is located so as to face the first position restriction member with the elastic part interposed therebetween.

3. A magnetic head device according to claim 1, wherein the second position restriction member restricts the position of the first position restriction member by contacting at least one of the elastic part and the first position restriction member.

4. A magnetic head device according to claim 1, wherein the second position restriction member is provided at the main part.

5. A magnetic head device according to claim 1, wherein the main part includes a rigid part connected to the elastic part and another elastic part connected to the rigid part.

6. A magnetic head device according to claim 5, wherein the elastic part, the rigid part and the another elastic part are formed of a supporting member.

7. A magnetic head device according to claim 6, wherein the main part further includes a fixing part for fixing the supporting member.

8. A magnetic head device according to claim 7, wherein the main part further includes an arm member, and the second position restriction member is attached to the arm member.

9. A magnetic head device according to claim 8, wherein the arm member is connected to the fixing part.

10. A magnetic head device according to claim 9, wherein the arm member is provided so as to be pivotable with respect to the fixing part.

11. A magnetic head device according to claim 8, the second position restriction member has a slidable projection at an end thereof.

12. A magnetic head device according to claim 11, wherein the slidable projection has a curved surface.

13. A magnetic head device according to claim 5, wherein the second position restriction member is provided at the rigid part.

14. A magnetic head device according to claim 5, wherein the first position restriction member is located in the vicinity of the center of gravity of the head main body.

15. A magnetic head device according to claim 1, wherein:
the connecting member has a free end and a fixed end, the elastic part of the connecting member is located on the side of the free end, and the main part is located on the side of the fixed end; and
the first position restriction member is located at an area of the head main body which is other than an area of the head main body closest to the fixed end of the connecting member.

16. A magnetic head device according to claim 1, wherein the first position restriction member is provided at the head main body, such that a force in a direction opposite to a direction in which the center of gravity of the head main body moves is given to the center of gravity of the head main body by the first position restriction member contacting the elastic part.

17. A magnetic head device according to claim 1, wherein the connecting member extends in a first direction, and the first position restriction member is provided so as to be perpendicular to the first direction.

18. A magnetic head device according to claim 1, further comprising a third position restriction member for restricting a position of the main part.

19. A magnetic head device according to claim 18, wherein the second position restriction member is attached to the third position restriction member.

20. A magnetic head device according to claim 1, further comprising a fourth position restriction member provided at the head main body for restricting a position of the head main body by contacting the main part.

21. A magnetic head device according to claim 1, which is movable between a first position, at which the head main body is slidable in contact with the information recording medium or floatable at a fine distance from the information recording medium, and a second position, at which the head main body is separated from the information recording medium.

22. A magnetic head device, comprising:
a head main body for applying a magnetic field to an information recording medium;
a connecting member including a main part and an elastic part connected to the main part, the elastic part supporting the head main body such that the head main body is swingable;
a first position restriction member provided at the head main body; and
a second position restriction member for restricting a position of the head main body by restricting a position of the first position restriction member;
wherein:
the main part includes a high rigidity part having a higher rigidity than the rigidity of the elastic part; and
the second position restriction member is connected to the high rigidity part.

23. A magnetic head device according to claim 22, wherein the second position restriction member restricts a position of the first position restriction member by contacting the first position restriction member.

24. A magnetic head device according to claim 23, wherein:
the elastic part has an opening; and
the first position restriction member moves in the opening of the elastic part to contact the second position restriction member.

25. A magnetic head device according to claim 23, wherein:
the elastic part has an opening;
the head main body is located in the opening of the elastic part;
the first position restriction member is provided at the head main body so as to bridge over the elastic part; and
a part of the first position restriction member moves outside the elastic part to contact the second position restriction member.

26. A magnetic head device according to claim 22, wherein:
the main part includes a rigid part connected to the elastic part, another elastic part connected to the rigid part, and a fixing part connected to the another elastic part;
the high rigidity part is the fixing part; and
the second position restriction member is connected to the fixing part.

27. A magnetic head device according to claim 22, wherein:
the main part includes a rigid part connected to the elastic part, and another elastic part connected to the rigid part;
the high rigidity part is the rigid part; and
the second position restriction member is connected to the rigid part.

28. A magneto-optical disc apparatus, comprising:
a magnetic head device according to claim 1; and
an optical head device.

29. A magneto-optical disc apparatus, comprising:
a magnetic head device according to claim 22; and
an optical head device.
